(19) United States
(12) Patent Application Publication
(10) Pub. No.: US 2010/0218618 A1
(43) Pub. Date: Sep. 2, 2010

(54) DOPPLER TYPE ULTRASONIC FLOW METER, FLOW METERING METHOD, AND COMPUTER PROGRAM

(75) Inventors: Michitsugu Mori, Tokyo (JP); Kenichi Tezuka, Tokyo (JP); Takeshi Suzuki, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: THE TOKYO ELECTRIC POWER CO., INC., Tokyo (JP)

(21) Appl. No.: 12/161,422

(22) PCT Filed: Jan. 18, 2007
(86) PCT No.: PCT/JP2007/050720

§ 371 Date: Nov. 10, 2009

(30) Foreign Application Priority Data
Jan. 20, 2006 (JP) 2006-012996

(51) Int. Cl. G01F 1/66

(52) U.S. Cl. 73/861.28

(57) ABSTRACT

Provided is a technique for performing a precise flow rate measurement of a large-bore pipeline without causing any aliasing. Ultrasonic pulses are transmitted at a first repetition frequency and at a second repetition frequency different from the first one, and a fluid velocity distribution measuring means measures a first flow velocity distribution for the first repetition frequency and a second flow velocity distribution for the second repetition frequency. A flow rate calculating means specifies either a first noise-superposed area to occur with the first repetition frequency or a second noise-superposed area to occur with the second repetition frequency, and calculates the flow velocity distribution either by eliminating the noise-superposed area from the first flow velocity distribution and interpolating it with the second flow velocity distribution or by eliminating the second noise-superposed area from the second flow velocity distribution and interpolating it with the first flow velocity distribution.

### TECHNICAL FIELD

The present invention relates to an ultrasonic flow meter capable of instantly measuring a flow rate of a fluid to be measured in time-dependence from a flow velocity distribution in a measurement area, and a technology relating thereof.

### BACKGROUND ART

As a prior art, in Japanese Patent Application Laid-open No. 2000-97742 disclosed in Patent Document 1, a Doppler type ultrasonic flow meter which can perform a precise measurement in non-contact, in time dependence with high reliability even for a flow in a non-stationary state is disclosed. The Doppler type ultrasonic flow meter disclosed here has a configuration described below.

That is, it includes an ultrasonic transmitting means for launching ultrasonic pulses having a required frequency f0 into a fluid to be measured from an ultrasonic transducer at a prescribed repetition frequency (fPRF), a fluid velocity distribution measuring means to receive an ultrasonic echo reflected by bubbles or the like in the fluid to be measured among the ultrasonic pulses launched into the fluid to be measured, and to measure a flow velocity distribution of the fluid to be measured in a measurement area, and a flow rate calculating means for performing an integral operation based on the flow velocity distribution of the above-described fluid to be measured. The flow rate calculating means measures a flow rate based on the flow velocity distribution of the fluid to be measured in the measurement area.

The Doppler type ultrasonic flow meter measures a flow velocity distribution of a fluid to be measured flowing in a pipeline, and shows outstanding performance in responsivity to the flow rate at a transitional period when the flow velocity distribution changes over time. It can measure instantly with a high degree of accuracy a flow rate of a fluid to be measured effectively even just after a position where a flow of the fluid has not sufficiently developed or a place where a flow is in a three dimensional state, for instance, just after a bent pipeline such as an elbow type pipeline or a U-shaped reversing pipeline. When compared with an ultrasonic flow meter previously provided, it has a characteristic that it can precisely measure without “a flow rate interpolation coefficient” deduced from an experimental value or an empirical value, and is greatly evaluated.

### Patent Document 1: Japanese Patent Application Laid-open No. 2000-97742

A recent ultrasonic flow meter is often provided as a single ultrasonic transmitting and receiving device (transducer) unified an ultrasonic oscillating device (emission) and a device to receive a reflected wave of the ultrasonic wave (receiver). For an ultrasonic flow meter which is separately provided with an ultrasonic oscillating device and a device for receiving a reflected wave of the ultrasonic wave, it is required to install the respective devices to a fluid pipeline with strict positioning. However, an ultrasonic flow meter provided as an ultrasonic transmitting and receiving device (transducer) has a merit of completing an installation work to a fluid pipeline in one time.

### DISCLOSURE OF THE INVENTION

### Problems to be Solved by the Invention

By the way, for a technology disclosed in the above-described Patent Document 1, a transmission frequency and a transmission interval (repetition frequency) of an ultrasonic wave are required to establish according to the size of a pipeline and a rough velocity of the fluid to be measured.

There are following limitations and conditions for the repetition frequency.

Firstly, it is required to repeat pulses at a frequency higher than a frequency determined from a Nyquist sampling therorem.

fPRF>4f0×V0×sin θ/C0 (Equation 1)

Here, as shown in FIG. 2, V0 is designated as a flow velocity of a fluid to be measured, C0 is designated as a velocity of sound in a fluid, and θ is designated as an incident angle. When transmitting the pulses at a repetition frequency lower than this frequency, measurement of a flow velocity distribution cannot be performed due to aliasing.

Secondly, when the ultrasonic wave is transmitted at an interval shorter than the time required for the ultrasonic wave reflected on a pipe wall on the opposite side to a launching part to arrive at a transducer, waves reflected from different incident waves are entangled (echo entanglement). Accordingly, in order to determine a flow velocity distribution in a pipeline, the interval of transmitting ultrasonic waves cannot be shorter than the time required for arrival of a first echo reflected from the pipeline. In other words, a repetition frequency fPRF cannot be equal to or higher than this frequency.

The first reason requires the higher the flow velocity, the higher the fPRF, while the second reason requires the larger the pipeline, the lower the fPRF. Accordingly, conditions for determining the flow rate of a flow having a large flow velocity in a large-bore pipeline are severe.

Actually, an echo from a different incident wave is sometimes superposed even when its repetition interval is made longer than the time required for arrival of the incident wave at the pipe wall. It comes from multiplexed echoes in a pipe. Among them, a second bottom surface echo shown in FIG. 6 gives especially a large influence. The second bottom surface echo is created such that an ultrasonic wave reflected on an inner wall of a pipeline at the bottom further reflects on an inner wall of the pipeline at the part where the ultrasonic wave was launched, reflects again on the inner wall of the pipeline at the bottom, and arrives at a transducer. The second bottom surface echo creates a noise area in a flow velocity distribution by the pulse launched next to the pulse concerned.

In order to avoid the influence by the second bottom surface echo, the interval of repetition should be made longer than the time required for a first bottom surface echo to arrive at the transducer. When a repetition frequency fPRF is made small, however, if there is a moment when the flow velocity becomes high due to an instant flow velocity change, the fPRF becomes too small at that moment, which sometimes causes aliasing.

A problem to be solved by the present invention is to provide a technology for performing a precise measurement without causing any aliasing, without being influenced by noise due to a multiplexed echo such as the second bottom surface echo when performing a flow velocity measurement of a fluid flowing mainly in a large-bore pipeline using a Doppler type ultrasonic flow meter.

An object of inventions described in claims 1 and 2 is to provide the Doppler type ultrasonic flow meter capable of performing such a precise measurement.

An object of inventions described in claims 3 and 4 is to provide a measurement method capable of performing such a precise measurement in a flow velocity measurement of a fluid flowing mainly in a large-bore pipeline using the Doppler type ultrasonic flow meter.

An object of inventions described in claims 5 and 6 is to provide a program product for performing such a precise measurement in a flow velocity measurement of a fluid flowing mainly in a large-bore pipeline using the Doppler type ultrasonic flow meter.

### Means for Solving the Problems

(Claim 1)

The invention described in claim 1 relates to a Doppler type ultrasonic flow meter including an ultrasonic transmitting means for launching ultrasonic pulses of an oscillation frequency (f0) into a fluid to be measured in a fluid pipeline along a measurement line at an incident angle (θ) at a repetition frequency (fPRF) from an ultrasonic transducer, a fluid velocity distribution measuring means to receive ultrasonic echoes reflected from a measurement area among the ultrasonic pulses launched into the fluid to be measured and to measure a flow velocity distribution of the fluid to be measured in the measurement area, and a flow rate calculating means for performing calculation of a flow rate of the fluid to be measured in the measurement area based on the flow velocity distribution of the fluid to be measured.

That is, the ultrasonic transmitting means transmits the ultrasonic pulses at two or more repetition frequencies;

the fluid velocity distribution measuring means specifies a noise-superposed area due to a multiplexed echo corresponding to one repetition frequency by measuring the flow velocity distributions from echoes at the respective repetition frequencies; and

the flow rate calculating means interpolates the flow velocity data in the noise-superposed area at the above-described one repetition frequency by the flow velocity data corresponding to the noise-superposed area in a flow velocity distribution at another repetition frequency.

(Explanation of Terms)

The present invention is to measure a flow velocity distribution of a fluid flowing in a so-called “large-bore pipeline” or a flow rate based on the flow velocity distribution. Here, the “large-bore pipeline” is effective when using for a pipe having a diameter of 1 meter or more.

However, it is an effective technology to be applied, not limited to the large-bore pipeline, but also to a case when the velocity of a fluid to be measured is high.

(Claim 2)

The invention described in claim 2 is to limit the invention described in claim 1 and relates to the Doppler type ultrasonic flow meter in which the multiplexed echo is a second bottom surface echo.

(Claim 3)

The invention described in claim 3 relates to a method of measuring a flow rate using a Doppler type ultrasonic flow meter to launch ultrasonic pulses of an oscillation frequency (f0) into a fluid to be measured in a fluid pipeline along a measurement line at an incident angle (θ) at a repetition frequency (fPRF) from an ultrasonic transducer, to receive an ultrasonic echo reflected from a measurement area among the ultrasonic pulses launched into the fluid to be measured, to measure a flow velocity distribution of the fluid to be measured in the measurement area, and to calculate a flow rate of the fluid to be measured in the measurement area based on the flow velocity distribution of the fluid to be measured.

That is, it includes the steps of: transmitting first ultrasonic pulses at a first repetition frequency; measuring a first flow velocity distribution from an ultrasonic echo corresponding to the first ultrasonic pulses; calculating a first multiplexed echo corresponding to the first repetition frequency; specifying a first noise-superposed area in the first flow velocity distribution so as to include the first multiplexed echo; transmitting second ultrasonic pulses at a second repetition frequency; measuring a second flow velocity distribution based on an ultrasonic echo corresponding to the second ultrasonic pulses; and interpolating the flow velocity data in the first noise-superposed area in the first flow velocity distribution using the flow velocity data corresponding to the first noise-superposed area in the second flow velocity distribution.

(Claim 4) p The invention described in claim 4 is to limit the invention described in claim 3, in which the multiplexed echo is a second bottom surface echo.

(Claim 5)

The invention described in claim 5 relates to a program product for measuring a flow rate to be used for a controller of the Doppler type ultrasonic flow meter to launch ultrasonic pulses of an oscillation frequency (f0) into a fluid to be measured in a fluid pipeline along a measurement line at an incident angle (θ) at a repetition frequency (fPRF) from an ultrasonic transducer, to receive an ultrasonic echo reflected from a measurement area among the ultrasonic pulses launched into the fluid to be measured, to measure a flow velocity distribution of the fluid to be measured in the measurement area, and to calculate a flow rate of the fluid to be measured in the measurement area based on the flow velocity distribution of the fluid to be measured.

The program product makes a control computer of the Doppler type ultrasonic flow meter execute the processing including the steps of: transmitting first ultrasonic pulse at a first repetition frequency; measuring a first flow velocity distribution from an ultrasonic echo corresponding to the first ultrasonic pulse; calculating a first multiplexed echo corresponding to the first repetition frequency; specifying a first noise-superposed area in the first flow velocity distribution so as to include the first multiplexed echo; transmitting second ultrasonic pulses at a second repetition frequency; measuring a second flow velocity distribution from an ultrasonic echo corresponding to the second ultrasonic pulse; and interpolating the flow velocity data in the first noise-superposed area in the first flow velocity distribution using the flow velocity data corresponding to the first noise-superposed area in the second flow velocity distribution.

(Claim 6)

The invention described in claim 6 is to limit the invention described in claim 5, and relates to the program product for measuring a flow rate, in which the multiplexed echo is a second bottom surface echo.

It is also possible to provide the computer program products described in claims 5 and 6 being stored in a record medium. Here, the “record medium” is a medium to be able to store a program product which cannot occupy a space by itself, and a flexible disc, a hard disc, a CD-R, an MO (magnetic optical disc), a DVD-R can be listed as an example.

By installing the computer program product described in claim 5 in a control computer of the Doppler type ultrasonic flow meter, it is also possible to provide the Doppler type ultrasonic flow meter described in claim 1.

The computer program products described in claims 5 and 6 can be also provided with a parameter inputting processing.

The parameter inputting processing may be only the repetition frequency (fPRF) which is a parameter voluntarily determined in the present invention. However, it is preferable to include parameters determined based on measurement conditions. The “parameters determined based on measurement conditions” are a bore size (D) of a pipeline, a rough flow velocity of a fluid to be measured, a velocity of sound (C0) in the fluid to be measured, and an incident angle (θ) of an ultrasonic wave.

### Effect of the Invention

According to the present invention, in a flow velocity measurement of a fluid flowing mainly in a large-bore pipeline by a Doppler type ultrasonic flow meter, a technology to perform a precise measurement while avoiding an influence of a noise caused by a multiplexed echo could be provided even in the case of being unable to select a repetition frequency which is too low in the view of aliasing.

### BRIEF DESCRIPTION OF DRAWINGS

FIG. 1 is a view showing a configuration of a Doppler type ultrasonic flow meter relating to the present invention;

FIG. 2 is a view to explain parameters of the Doppler type ultrasonic flow meter;

FIG. 3 is a view to explain a principle of occurring noise due to a second bottom surface echo;

FIGS. 4A and 4B show a part where noise exists and a part to be interpolated;

FIG. 4C shows a flow velocity distribution after the interpolation;

FIG. 5 shows an example of a flow chart of the present invention; and

FIG. 6 is a view showing a concept of the second bottom surface echo.

### BEST MODE FOR CARRYING OUT THE INVENTION

An embodiment of a Doppler type ultrasonic flow meter relating to the present invention will be explained referring to attached drawings.

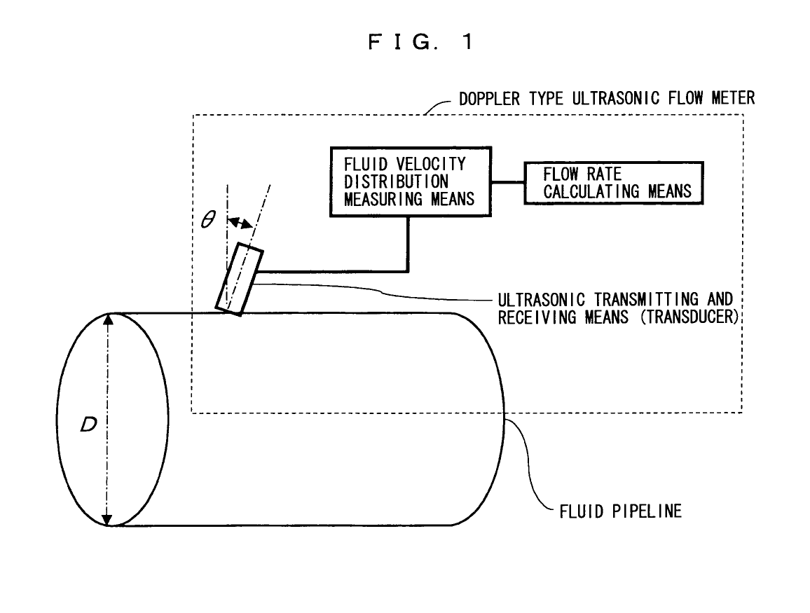

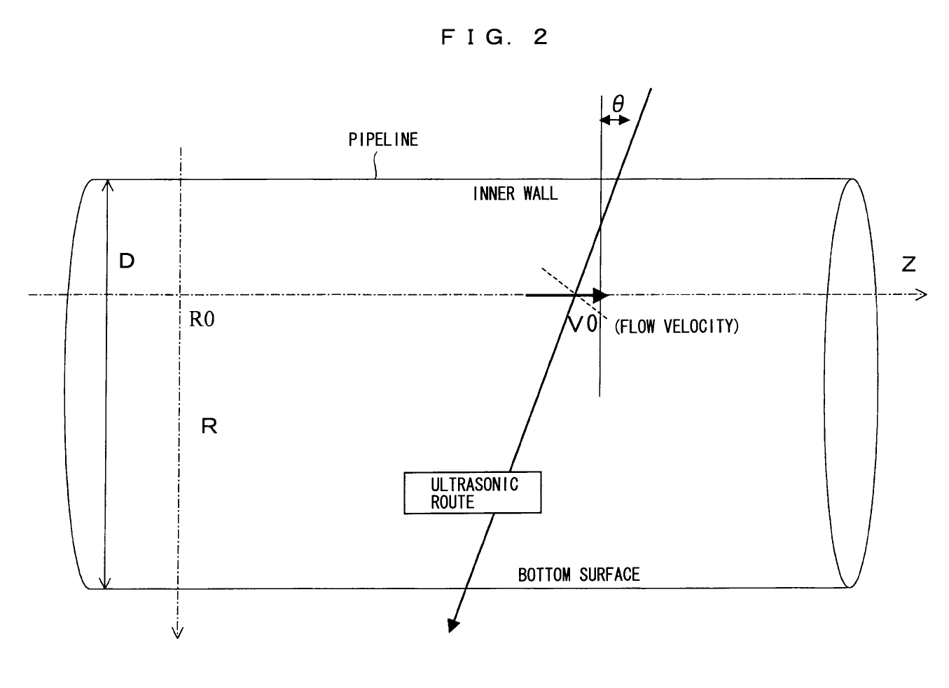

FIG. 1 shows a configuration of the Doppler type ultrasonic flow meter relating to the present invention, which includes a transducer being an ultrasonic transmitting means, a flow velocity distribution measuring means and a flow rate calculating means. As shown in FIG. 2, as for the Doppler type ultrasonic flow meter, a common oscillation frequency (f0) is a solid value (typically 1 MHz). At a site where an ultrasonic flow meter is scheduled to be installed (or as prior information), a bore size (D) of a fluid pipeline can be known, and an ultrasonic velocity in a fluid to be measured can be known from a kind of the fluid to be measured. Accordingly, a value to be adjusted is only an incident angle (θ) of an ultrasonic pulse and a repetition frequency (fPRF).

The incident angle (θ) is determined by selecting a wedge from several kinds of wedges prepared beforehand. In other words, the wedge is adopted as a jig to fix an ultrasonic transducer to the surface of a pipeline through which the fluid to be measured flows. The wedge has an angle beforehand, and the angle corresponds to the incident angle (θ) of the ultrasonic pulse.

Though the larger the incident angle (θ), the higher the measurement precision, when the velocity of a fluid to be measured is high, the incident angle (θ) should be inevitably small. Accordingly, it is limited to some extent according to the flow velocity of a fluid to be measured. Besides, since it is selected from among several kinds of wedges, it is difficult to finely adjust the incident angle (θ).

As above, a variable possible to be easily replaced is only a repetition frequency (fPRF).

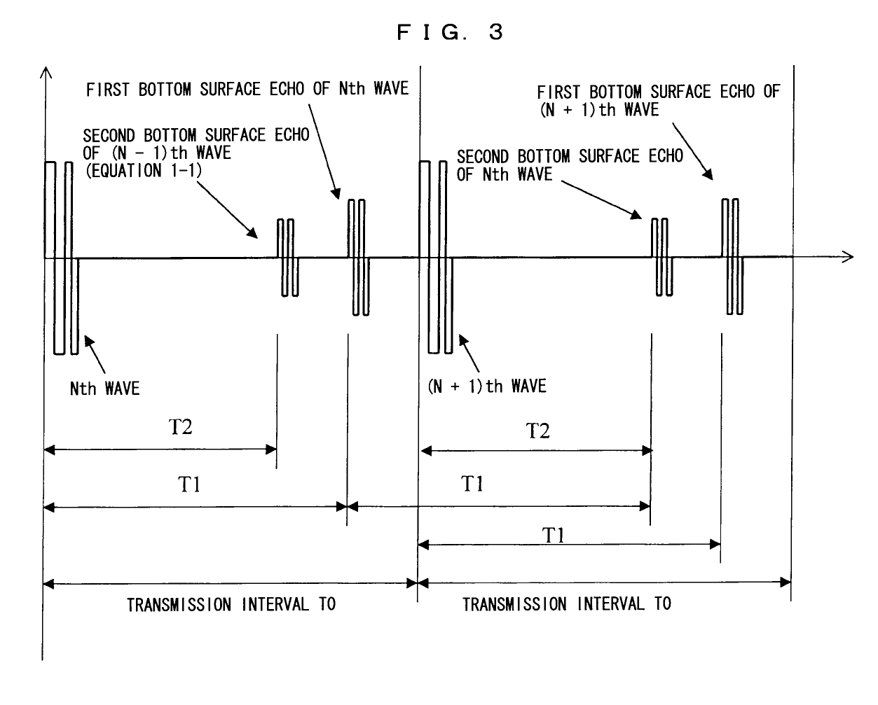

A noise area created by a second bottom surface echo will be explained next based on FIG. 3.

A transmission interval is designated as T0, an interval till a first bottom surface echo is received, which is determined from the bore size of the pipeline is designated as T1, and a required transmission interval is designated as T2. A temporarily established repetition frequency is designated as fPRF, a diameter of the pipeline through which the fluid to be measured flows is designated as D, a velocity of sound in the fluid to be determined is designated as C0, an incident angle of an ultrasonic wave used for measurement is designated as θ, the center of the pipeline along an ultrasonic route in the pipeline is designated as R0, and a Doppler signal is designated as Δf.

From the above conditions, the following equation is realized.

T0=1/fPRF (Equation 2)

Since the first bottom surface echo is a time to go and return in the pipeline, the following equation can be realized.

T1=2D/(C0×cos θ) (Equation 3)

In addition, since there is the following relation between T2, T1 and T0,

T2=2×T1−T0

when T1 and T0 is in a relation expressed as below

2×T1>T0 (Equation 4)

the second bottom surface echo noise is superposed on a flow velocity distribution, and its position is as below.

T2=4D/(C0×cos θ)−1/fPRF (Equation 5)

When a repetition frequency (fPRF) is made large, DT1/T2 becomes large. Accordingly, the position of the noise in the flow velocity distribution appears on a farther side from an inner pipe wall in the radial direction of the pipeline. While when the repetition frequency (fPRF) is made small, DT1/T2 becomes small. Accordingly, the position of the noise in the flow velocity distribution appears on a nearer side from an inner pipe wall in the radial direction of the pipeline.

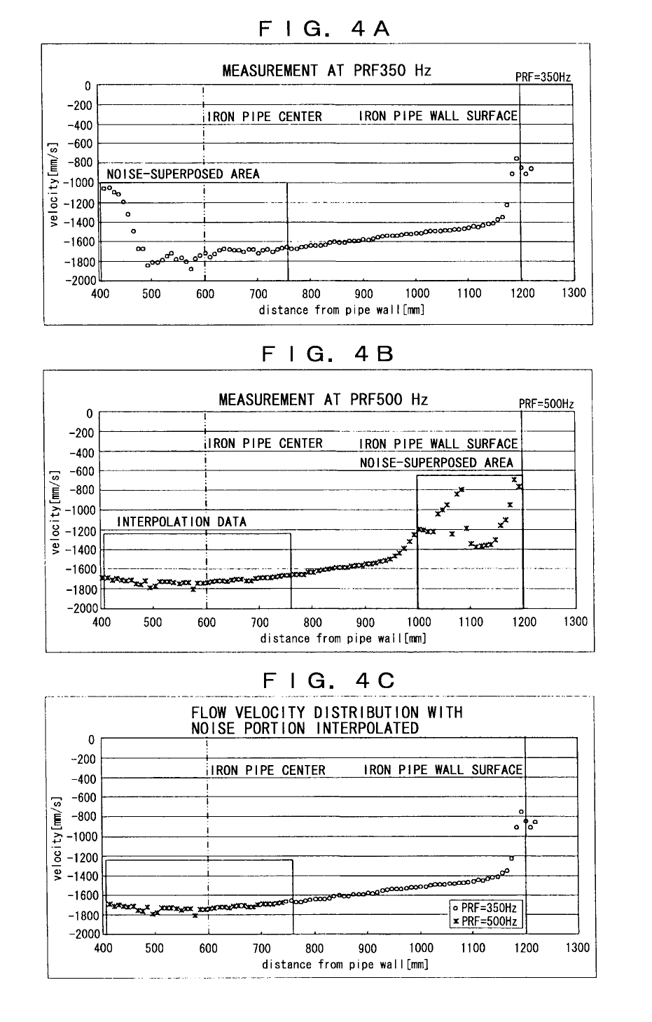

A method of interpolating a noise area due to the second bottom surface echo will be explained using FIGS. 4A, 4B and 4C next.

As shown in FIG. 4A, for a fluid to be measured in a bore-size 1200 (mm), in the case of the repetition frequency fPRF at 350 (Hz), T2 is 0.926 (ms), and the second bottom surface echo superposes around the vicinity of the pipeline center (at the position of 49% away from the pipe wall). Accordingly, the area having 30% of the bore size around the position 49% away from the inner wall of the pipeline is determined as a noise-superposed area. Actually, the size of the noise-superposed area differs according to a measurement environment, it is possible to grasp almost all of the influenced area by taking as much as 30% of the bore size of the pipeline as the size of the noise-superposed area.

Further, as shown in FIG. 4B, in the case of the repetition frequency fPRF at 500 (Hz), T2 is 1.78 (ms), and the second bottom surface echo is superposed around the vicinity of the inner wall of the pipeline (at the position of 94% away from the pipe wall). The transmission interval T0 in FIGS. 4A, 4B and 4C is taken to 2.857 (ms), the velocity of sound in water is taken to 1400 (m/s).

From this circumstance, the flow velocity data at a distance from the inner wall of the pipeline from 408 (mm) to 768 (mm) in the flow velocity distribution at the repetition frequency fPRT of 350 Hz is replaced by the flow velocity distribution data at the repetition frequency fPRT of 500 Hz. By this procedure, it becomes possible to obtain a flow velocity distribution from which the noise area is removed as shown in FIG. 4C. It is also possible to similarly obtain a flow velocity distribution from which the noise area is removed by replacing the data of a portion at a distance from the inner wall of the pipeline from 972 (mm) to 1200 (mm) in the flow velocity distribution at the repetition frequency fPRF of 500 Hz by the data at the repetition frequency fPRT of 350 Hz.

The present embodiment is for the noise areas due to the second bottom surface echo, but the scope of the present invention is not limited to this, it is possible to widely apply to interpolate noise areas having correlation with the repetition frequency.

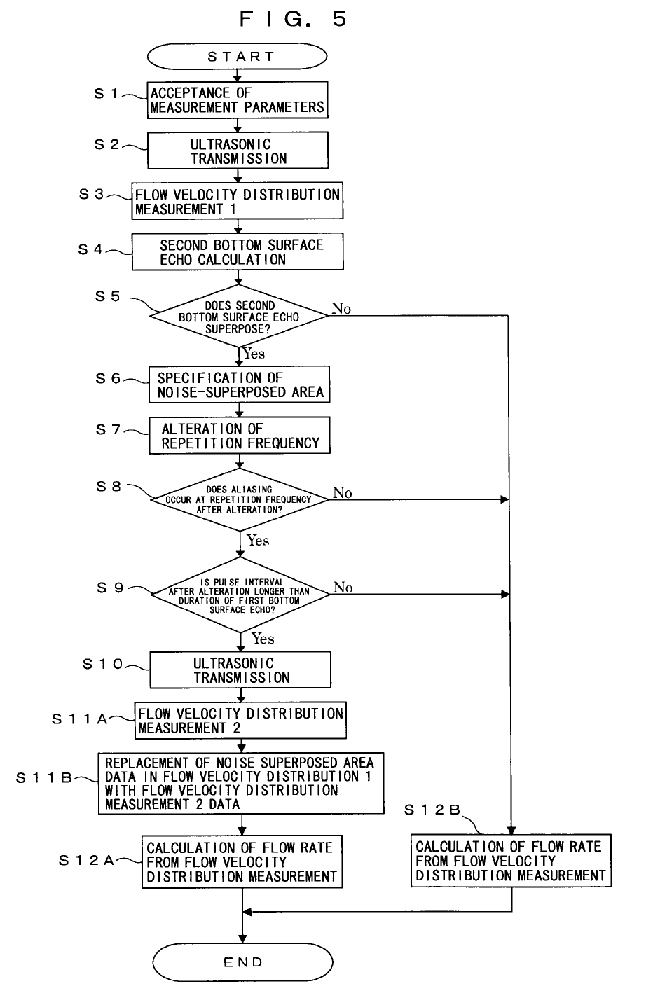

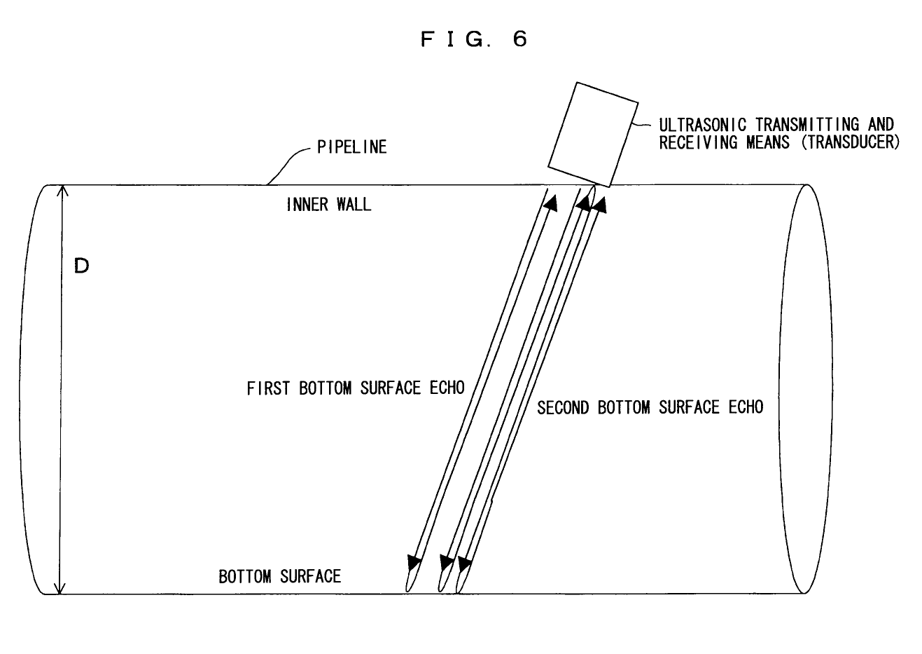

An operation example of a flow rate measurement program product relating to the present invention will be explained using a flow chart shown in FIG. 5.

First, inputting of an incident angle (θ), a fundamental frequency (f0), a repetition frequency (fPRF), a bore size (D) and a rough flow velocity (V0) is accepted (S1).

An ultrasonic pulse is transmitted with given parameters (S2) to execute measurement of the flow velocity distribution (S3).

From the parameters, T2 is calculated to specify a position where the second bottom surface echo is superposed (S4), and whether or not the noise due to the second bottom surface echo is superposed on the flow velocity distribution is determined (S5).

Note that it is also possible to exchange the sequence of transmission of the ultrasonic pulse (S1), measurement of the flow velocity distribution (S2) and specification of the second bottom surface echo (S4), determination of existence or absence of superimposition (S5).

When noise due to the second bottom surface echo is superposed on the flow velocity distribution, the area is specified (S6). Although the noise due to the second bottom surface echo influences some extent of areas around T2, and the size thereof differs according to the measurement environment, by specifying 30% of the pipeline around T2 as a noise area, almost all influence can be handled.

When the noise due to the second bottom surface echo is determined to be superposed, the measurement is repeated once more. At that time, only the repetition frequency among the parameters used for the first measurement is altered (S7). When the repetition frequency is altered, it is necessary to set T2 to differ at least as much as 30% or more of the pipeline so as not to overlap a noise-superposed area at the first time and a noise-superposed area at the second time.

With the parameters thus established, whether or not it satisfies the lowest limit of frequency where no aliasing occurs (S8) and the highest limit of frequency where no echo entanglement occurs for the respective pulses (S9) is confirmed, and if not, the second measurement is not executed.

When it satisfies the conditions for aliasing and non-entanglement with echo, an ultrasonic pulse is transmitted with re-established parameters (S10), the flow velocity distribution measurement 2 is executed (S11A) The data of the flow velocity distribution 1 in the noise-superposed area is replaced by the data obtained here (S11B). Using the flow velocity distribution after this interpolation, a flow rate is calculated (S12A).

Note that when a noise is not superposed, or when the repetition frequency at the second time could not be established, the flow rate is calculated from the result of the flow velocity distribution measurement 1 (S12B).

### INDUSTRIAL APPLICABILITY

The present invention is a technology adopted when a flow rate of a fluid flowing mainly in a large-bore pipeline at a high flow velocity is measured. It can be adopted, for instant, in the flow rate measurement for a pipeline in a hydroelectric power generation plant.

1. A Doppler type ultrasonic flow meter comprising:
an ultrasonic transmitting means for launching ultrasonic pulses of an oscillation frequency (f0) into a fluid to be measured in a fluid pipeline along a measurement line at an incident angle (θ) at a repetition frequency (fPRF) from an ultrasonic transducer;
a flow velocity distribution measuring means to receive ultrasonic echoes reflected from a measurement area among the ultrasonic pulses launched into the fluid to be measured and to measure a flow velocity distribution of the fluid to be measured in the measurement area; and
a flow rate calculating means for performing calculation of a flow rate of the fluid to be measured in the measurement area based on the flow velocity distribution of the fluid to be measured,
wherein said ultrasonic transmitting means transmits the ultrasonic pulses at two or more repetition frequencies;
said flow velocity distribution measuring means specifies a noise-superposed area due to a multiplexed echo corresponding to one repetition frequency by measuring the flow velocity distributions from echoes at the respective repetition frequencies; and
said flow rate calculating means interpolates the flow velocity data in the noise-superposed area at the above-described one repetition frequency by the flow velocity data corresponding to the noise-superposed area in the flow velocity distribution at another repetition frequency.

2. The Doppler type ultrasonic flow meter according to claim 1,
wherein the multiplexed echo is a second bottom surface echo.

3. A method of measuring a flow rate using a Doppler type ultrasonic flow meter:
to launch ultrasonic pulses of an oscillation frequency (f0) into a fluid to be measured in a fluid pipeline along a measurement line at an incident angle (θ) at a repetition frequency (fPRF) from an ultrasonic transducer;
to receive an ultrasonic echo reflected from a measurement area among the ultrasonic pulses launched into the fluid to be measured;
to measure a flow velocity distribution of the fluid to be measured in the measurement area; and
to calculate a flow rate of the fluid to be measured in the measurement area based on the flow velocity distribution of the fluid to be measured,
said method of measuring a flow rate comprising the steps of:
transmitting first ultrasonic pulses at a first repetition frequency;
measuring a first flow velocity distribution from an ultrasonic echo corresponding to the first ultrasonic pulses;
calculating a first multiplexed echo corresponding to the first repetition frequency;
specifying a first noise-superposed area in the first flow velocity distribution so as to include the first multiplexed echo;
transmitting second ultrasonic pulses at a second repetition frequency;
measuring a second flow velocity distribution based on the ultrasonic echo corresponding to the second ultrasonic pulses; and
interpolating the flow velocity data in the first noise-superposed area in the first flow velocity distribution using the flow velocity data corresponding to the first noise-superposed area in the second flow velocity distribution.

4. The method of measuring the flow rate according to claim 3, wherein the multiplexed echo is a second bottom surface echo.

5. A program product for measuring a flow rate to be used for a controller of the Doppler type ultrasonic flow meter,
to launch ultrasonic pulses of an oscillation frequency (f0) into a fluid to be measured in a fluid pipeline along a measurement line at an incident angle (θ) at a repetition frequency (fPRF) from an ultrasonic transducer;
to receive an ultrasonic echo reflected from a measurement area among the ultrasonic pulses launched into the fluid to be measured;
to measure a flow velocity distribution of the fluid to be measured in the measurement area; and
to calculate a flow rate of the fluid to be measured in the measurement area based on the flow velocity distribution of the fluid to be measured,
said program product for measuring a flow rate makes the control computer of the Doppler type ultrasonic flow meter execute the processing comprising the steps of:
transmitting first ultrasonic pulses at a first repetition frequency;
measuring a first flow velocity distribution from an ultrasonic echo corresponding to the first ultrasonic pulse;
calculating a first multiplexed echo corresponding to the first repetition frequency;
specifying a first noise-superposed area in the first flow velocity distribution so as to include the first multiplexed echo;
transmitting second ultrasonic pulses at a second repetition frequency;
measuring a second flow velocity distribution from an ultrasonic echo corresponding to the second ultrasonic pulse; and
interpolating the flow velocity data in the first noise-superposed area in the first flow velocity distribution using the flow velocity data corresponding to the first noise-superposed area in the second flow velocity distribution.

6. The program product for measuring a flow rate according to claim 5, wherein the multiplexed echo is a second bottom surface echo.
